(19) United States
(12) Patent Application Publication
(10) Pub. No.: US 2014/0290812 A1
(43) Pub. Date: Oct. 2, 2014

(54) BARBEQUE COVER

(71) Applicants: Matthew David Chaplin, Calgary (CA); Sacha Kristen Hockenhull, Calgary (CA)

(72) Inventors: Matthew David Chaplin, Calgary (CA); Sacha Kristen Hockenhull, Calgary (CA)

(21) Appl. No.: 14/227,247

(22) Filed: Mar. 27, 2014

Related U.S. Application Data
(60) Provisional application No. 61/805,567, filed on Mar. 27, 2013.

(51) Int. Cl. A47J 37/07

(52) U.S. Cl. CPC A47J 37/0786
USPC 150/165

(57) ABSTRACT

A structurally reinforced barbeque cover having ribs is provided for use in combination with a barbeque having a retaining bracket, to provide convenient storage of the cover while the barbeque is in operation.

### CROSS-REFERENCE TO RELATED APPLICATIONS

This application claims the benefit of priority from U.S. provisional application Ser. No. 61/805,567, filed on Mar. 27, 2013, which is hereby incorporated by reference herein.

### FIELD OF THE INVENTION

The present invention relates to in situ storage of weather resistant coverings for barbeques. In particular, the present invention relates to a structurally reinforced barbeque cover.

### BACKGROUND OF THE INVENTION

Barbeques are typically used and stored outside, which exposes them to the elements. Barbeque covers are provided to protect the equipment and must be removed prior to operation of the barbeque.

There is no easy way to store the barbeque cover and typically it is bunched and placed on any adjacent surface or structure proximate to the barbeque, which is unsightly and inconvenient. Replacing the cover requires manipulation to place the open end over the barbeque and all of this takes time and effort.

### SUMMARY OF THE INVENTION

An object of the present invention is to offer a solution to the above problem by providing means and method to conveniently store the cover in situ.

Another object of the present invention is to provide a barbeque cover for use in combination with a barbeque having a retaining bracket attached to one side and a cover sheet. The cover sheet is operatively connected on one side to the retaining bracket and has a plurality of spaced apart ribs attached thereto for providing a deformable structure to the cover. A handle attached to the cover sheet is used to uncover the barbeque and store the cover sheet on the retaining bracket. Covering the barbeque requires the opposite action.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a side view of a barbeque cover in the covered position; and

FIG. 2 is a side view of a barbeque cover in the stored position.

### DESCRIPTION OF PREFERRED EMBODIMENTS

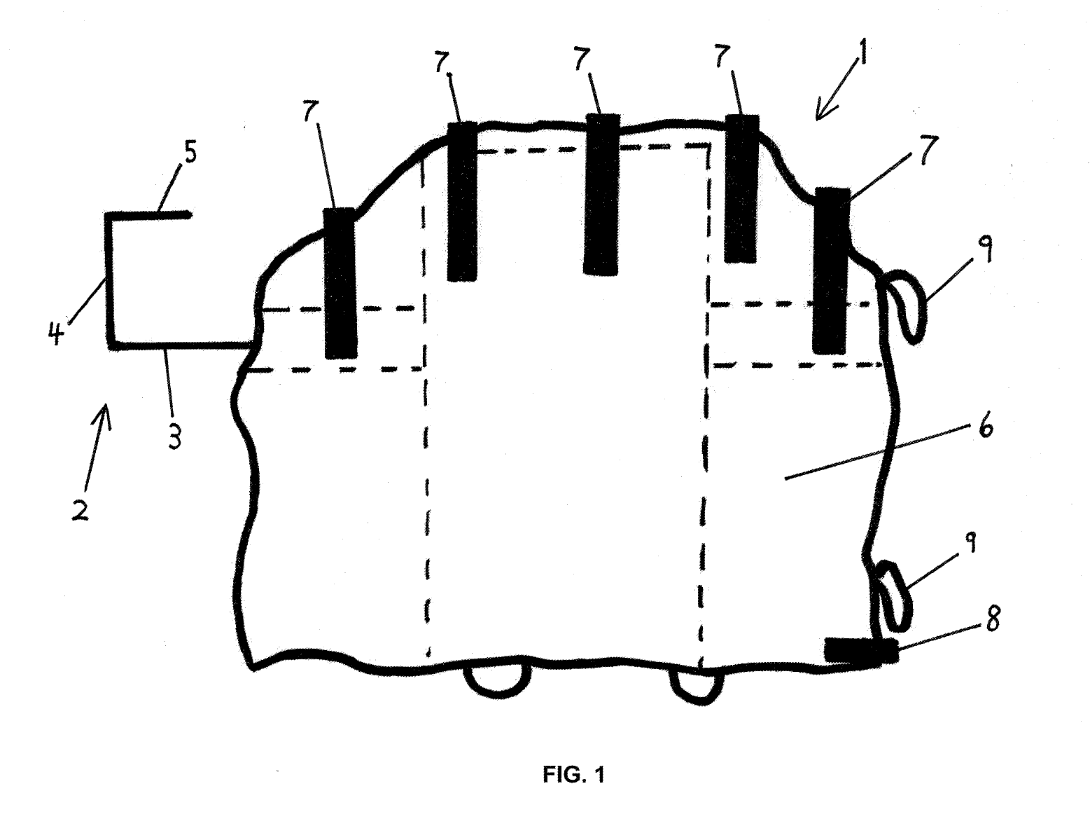

As shown in FIG. 1, a barbeque cover 1 according to the present invention is provided for use in combination with a barbeque. Typically, the barbeque has a frame mounted cooking chamber, with shelves extending laterally on both sides.

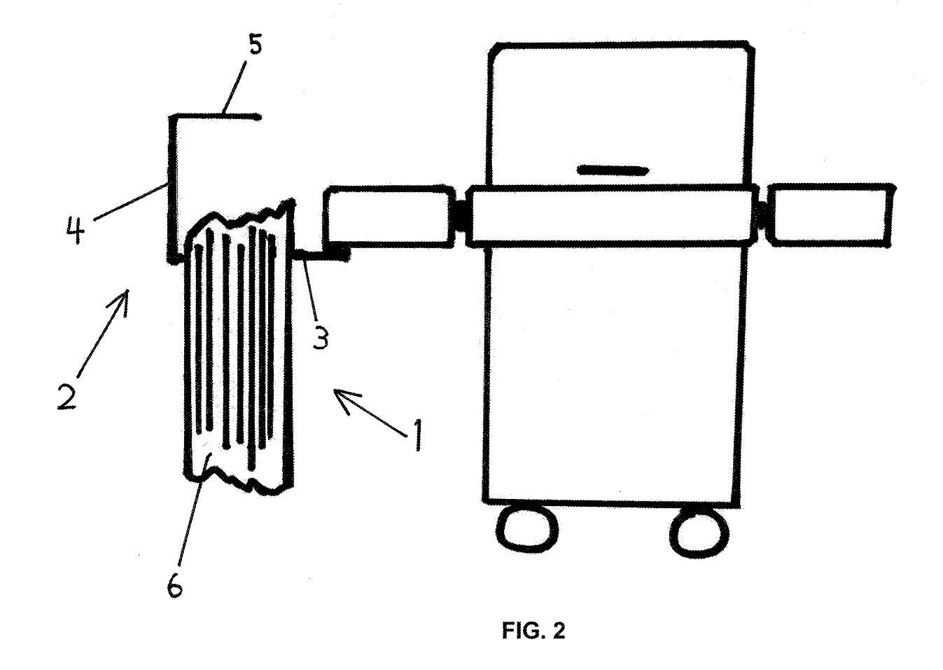

The barbeque has a retaining bracket 2 attached to one end of the barbeque, as shown in FIGS. 1 and 2. The retaining bracket 2 has a horizontal section 3 that extends outwardly from the barbeque and a vertical section 4 at the outward end of the horizontal section 3 for supporting and retaining the cover 1 in the stored position, as shown in FIG. 2. The horizontal section 3 may be curved downwardly along its side edges to provide a rounded surface. The vertical section 4 retains the cover 1 in the stored position and prevents it from falling off the outside edge of the horizontal section 3. Preferably, the barbeque has a shelf extending to one side and the horizontal section 3 of the retaining bracket 2 is attached to the outside edge of the shelf, as shown in FIG. 2.

The retaining bracket 2 may optionally have a second horizontal section 5 attached to the top edge of the vertical section 4 to provide an additional usable horizontal surface. Preferably, the second horizontal section 5 is attached to the vertical section 4 by a hinge mechanism, or other suitable mechanism, with a stop that allows the second horizontal section 5 to pivot outwardly, but prevents it from pivoting toward the barbeque below a plane parallel to the horizontal section 3. This permits the second horizontal section 5 to pivot upwardly and outwardly to facilitate movement of the cover 1 between the covered position and the stored position or vice versa. The second horizontal section 5 may be provided with a cup holder on its top surface.

The retaining bracket 2 may be made of any rigid material that is capable of supporting the weight of the cover 1 and withstanding the temperatures encountered in close proximity to the cooking chamber of the barbeque. Preferably, the retaining bracket 2 is bolted to the barbeque, but other methods of attachment may also be used.

When the cover 1 is in the stored position on the retaining bracket 2, as shown in FIG. 2, it does not obstruct or interfere with the cooking process and the shelves of the barbeque are fully useably.

The cover 1 has a cover sheet 6 with a plurality of spaced apart ribs 7, or battens, attached thereto to give the cover 1 a deformable structure. The cover sheet 6 is typically shaped to fit over and cover the barbeque and may be of any shape or size to accommodate different barbeques. Optionally, excess material may be folded and secured at points along the cover sheet 6, provided with attachment means to adapt the cover 1 to various shapes and sizes of barbeques. An aperture in the cover sheet 6, on either the right or left hand side of the cover 1, proximate to the retaining bracket 2, is provided to enable the cover 1 to be fitted over the retaining bracket 2 and operatively connected thereto. In one embodiment, the cover 1 is fixedly attached to the retaining bracket 2, for example, by rivets or bolts. Alternatively, the cover 1 may be releasably attached to the retaining bracket 2, for example, by buttons or hook and loop material, or slidably engaged by means of the aperture being fitted over the retaining bracket 2.

The cover sheet 6 may be made of any suitable protective material to shield the barbeque from the elements when not in use. Preferably, the material is also heat-resistant to allow the user to cover the barbeque after use, without having to wait until the exterior surface of the barbeque has completely cooled. Preferably, the cover sheet 6 is made of weatherproof fabric suitable for a temperature range of between −70 degrees to +250 degrees Celsius.

As shown in FIG. 1, the cover 1 is provided with a rib-like skeletal structure. Ribs 7 are attached to the flexible sheet 6 and are arranged in spaced apart relation to one another. The ribs 7 are made of a stiff material that is strong enough to substantially hold its shape under the weight of the cover 1 and provide a deformable skeletal structure to the cover sheet 6 that facilitates the covering and uncovering of the barbeque. The ribs 7 may be shaped to the contour of the cooking chamber. Preferably, the ribs 7 are sewn into the cover sheet 6 so as to form an integral part of the cover 1. Alternatively, the ribs 7 may be inserted into sleeves in the cover sheet 6.

The ribs 7 are spaced apart to provide a skeletal structure to the cover 1 and allow the cover 1 to be folded up or gathered when in the stored position. Preferably, the ribs 7 are spaced apart laterally along the top portion of the cover 1, between opposing sides of the cover sheet 6, as shown in FIG. 1. A bottom rib 8 may be provided at the bottom edge of the cover 1 on the side opposite the retaining bracket 2 to facilitate the covering an uncovering operation and provide weight to the bottom edge of the cover 1 to fully enclose the barbecue within the cover 1, when the cover 1 is in the covered position.

One or more handles 9 are provided on the cover 1 to allow a user to easily grip the cover 1 and move and manipulate it between a stored position and a covered position and vice versa. The handles 9 are attached to the outside of the cover 1, as shown in FIG. 1. Preferably, the handles 9 are loops of resilient fabric and may be sewn to the ribs 7.

To open the cover 1 from the covered position to the stored position, a user grips the handle 9 and pulls the cover 1 towards the retaining bracket 2, over the cooking chamber, and rests the cover 1 on the horizontal section 3 of the retaining bracket 2. To close the cover 1, a user grips the handle 9 and pulls away from the retaining bracket 2, towards the other end of the barbeque.

Other advantages which are inherent to the cover are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the disclosure and the appended claims.

What is claimed is:

1. A barbeque cover for use in combination with a barbeque having a retaining bracket attached on one side,
wherein the retaining bracket has a horizontal section, having side edges, attached to the barbeque and a vertical section attached to the horizontal section, and
wherein the barbeque cover comprises:
a cover sheet operatively connected on one side to the retaining bracket, the cover sheet having a plurality of spaced apart ribs attached thereto for providing a deformable structure to the cover sheet, and
a handle attached to the cover sheet for use in uncovering the barbeque and storing the cover on the retaining bracket.

2. The barbeque cover of claim 1, wherein the horizontal section is curved downwardly along the side edges.

3. The barbeque cover of claim 1, wherein the retaining bracket further comprises a second horizontal section attached to the top edge of the vertical section and extending inwardly toward the barbeque.

4. The barbecue cover of claim 3, wherein the second horizontal section is pivotally attached to the top edge of the vertical section by way of a hinge mechanism with a stop that prevents the second horizontal section from pivoting toward the barbeque below a plane parallel to the horizontal section.

5. The barbeque cover of claim 1, further comprising an aperture through the cover sheet proximate to the retaining bracket.

6. The barbeque cover of claim 5, wherein the cover sheet is fixedly attached to the retaining bracket.

7. The barbeque cover of claim 5, wherein the cover sheet is slidably attached to the retaining bracket by means of the aperture being fitted over the retaining bracket.

8. The barbeque cover of claim 1, wherein the ribs are sewn into the cover sheet.

9. The barbeque cover of claim 1, wherein the ribs are inserted into sleeves in the cover sheet.

10. The barbeque cover of claim 1, wherein the ribs are spaced apart laterally along the top portion of the cover between opposing sides of the cover sheet.

11. The barbeque cover of claim 10, further comprising a bottom rib attached to the bottom edge of the cover sheet on the side opposite the retaining bracket.

12. The barbeque cover of claim 1, wherein the handle is attached to a rib.

13. The barbeque cover of claim 12, wherein the handle comprises one or more handles, each attached to a different rib.

14. The barbeque cover of claim 11, wherein the handle comprises one or more handles, each attached to a different rib, wherein at least one of the one or more handles is attached to the bottom rib.

15. A method of covering or uncovering a barbeque with a barbeque cover, wherein the barbeque has a retaining bracket attached on one side, having a horizontal section, having side edges, attached to the barbeque and a vertical section attached to the horizontal section, and wherein the barbeque cover comprises a cover sheet operatively connected on one side to the retaining bracket, the cover sheet having a plurality of spaced apart ribs attached thereto for providing a deformable structure to the cover sheet, and a handle attached to the cover sheet for use in uncovering the barbeque and storing the cover on the retaining bracket,
comprising the steps of:
gripping the handle of the barbeque cover; and
using the handle to cover the barbeque by pulling the barbeque cover from a stored position, wherein the flexible sheet is retained on the holding bracket, across the barbeque to a covered position, wherein the flexible sheet is fitted over and substantially surrounds the barbeque; or uncover the barbeque by pulling the barbeque cover from the covered position across the barbeque to the stored position.
